(19) United States
(12) Patent Application Publication
(10) Pub. No.: US 2025/0088055 A1
(43) Pub. Date: Mar. 13, 2025

(54) NO-MAGNET MOTOR USING LINEAR MOTOR STATOR WINDINGS ARRANGED IN CYLINDRICAL CONFIGURATIONS

(71) Applicant: Daniel P. Jones, Pinellas Park, FL (US)

(72) Inventor: Daniel P. Jones, Pinellas Park, FL (US)

(21) Appl. No.: 18/243,179

(22) Filed: Sep. 7, 2023

(51) Int. Cl. H02K 3/04

(52) U.S. Cl. CPC H02K 3/04

(57) ABSTRACT

The invention relates to a no-magnet customizable motor utilizing stator slice sub-assemblies using linear motor stator windings arranged in cylindrical configurations. The no-magnet slice motor drive system is comprised of a stator, which is plug-able to adjacent stator slices, arranged surrounding a non-magnetic electrically conductive rotor. Each stator may be connected either in series or parallel to adjacent stators. The rotor, in the form of a customizable length cylinder, is comprised of a non-magnetic electrically conductive material. No permanent magnets are used in the design of the motor. This basic no-magnet motor design approach is scaleable.

### CROSS-REFERENCE TO RELATED APPLICATIONS

application Ser. No. 18/324,294

### PRIOR ART

U.S. PATENT DOCUMENTS

| | | | |
|---|---|---|---|
| US11258320B2 | 20/22/2020 | Fred E. Hunstable | H02K1/2793 |
| 9,617,089 | Apr. 11, 2017 | Josefowitz et al. | B65G54/02 |

FOREIGN PATENT DOCUMENTS

| | | | |
|---|---|---|---|
| WO2020079869A1 | Apr. 23, 2020 | KYB | H02K41/031 |
| JP6584619B2 | Oct. 4, 2018 | Hitachi Ltd | H02K41/031 |

### BACKGROUND OF THE INVENTION

Linear engine drives are well known in the state of the art. Examples are a high-speed passenger train or individual transport of single items in manufacturing lines. All use linear motors to move items in only translational movement. This common feature can be overcome with a unique configuration on the stator design to allow complete rotational movement of a non-magnetic electrically conductive rotor.

### SUMMARY OF THE INVENTION

The invention is a no-magnet stator slice motor drive system using a linear motor stator grouping arranged in a cylindrical configuration surrounding a non-magnetic electrically conductive rotor. Each stator group with windings are arranged in a cylindrical configuration, and for three phase electrical operation. The invention also relates to the frequency driven speed to control the rotor rotation.

This disclosure provides a cylindrical configuration of stator linear motor windings that produces a no-magnet motor that is easy to configure and produce. This embodiment provides for a configuration of linear motor stator windings in a cylindrical configuration. In a first embodiment, a single stator slice is used to drive the rotor. In the second embodiment, an example three stator slice configuration is presented but any number of additional stator slices can be plugged together, which may require additional center supports on the rotor and motor housing. The current embodiment uses three phase current at varying frequency to produce rotational movement of the rotor, but other phasing and waveforms will work as well. Permanent magnets are used in the design of any embodiment. No complex drive control mechanism is required as motor is simply driven by variable frequency three phase input currents.

### BRIEF DESCRIPTION OF DRAWINGS

For a more complete understanding of this disclosure and features, reference is made to the following description, along with the related drawings, in which:

FIGS. 1, 2 and 3 illustrate an example no-magnet motor in accordance with this disclosure. FIG. 1 is a single slice configuration, FIG. 2 is a three slice configuration and FIG. 3 is an exploded view of a three slice configuration. Additional slice configurations are possible, but not shown.

FIG. 4 illustrates an example construction of this disclosure in cross-section.

FIG. 5 illustrates how, as an example, stator slices can be arranged in a two group configuration.

FIG. 6 illustrates how a linear motor stator cores can be arranged in a cylindrical configuration.

FIG. 7 illustrates an example rotor design.

FIG. 8 illustrates a no-magnet motor with an integral cooling system.

FIG. 9 illustrates a cross-section of the integral cooling system.

### DETAILED DESCRIPTION OF THE INVENTION

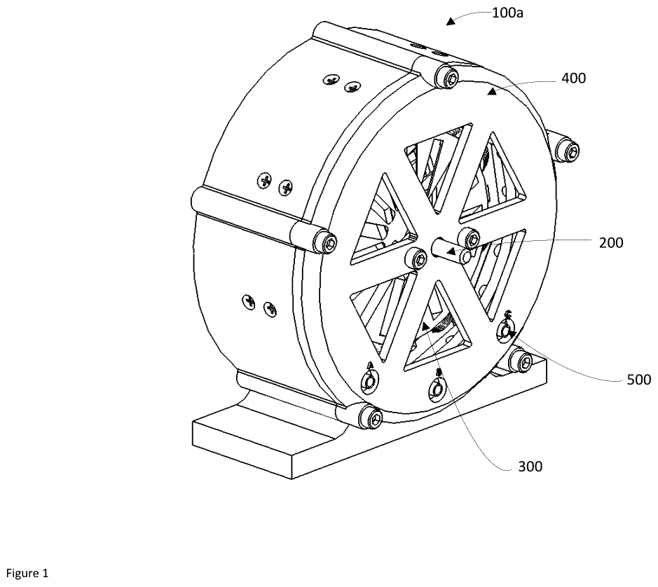

FIGS. 1 through 9, described below, and the various representations used to describe the principles of the present invention in this document are by way of illustration only and should not be construed in any way to limit the scope of the invention. Those skilled in the art will understand that the principles of the present invention may be implemented in any type of suitable arranged device or system.

The invention relates to a no-magnet slice motor drive system as a linear motor stator grouping arranged in a cylindrical configuration surrounding a non-magnetic electrically conductive rotor. Stator groups as configurable plug-in construction allows for both torque and speed increase with the addition of additional stator slices. Speed may be increased by advancing the frequency of the input waveform. The magnetic field produced by the stator windings will create an opposite corresponding current and associated magnetic field in the non-magnetic electrically conductive rotor, causing it to spin. The induced current will produce a magnetic field opposing the change in magnetic flux in the stator windings, generating the force to induce rotor motion. Three phase electrical input wave form will allow the changing induced current in the non-magnetic electrically conductive rotor to produce the rotational spin of the rotor.

This disclosure provides a configuration for a stator that may be used to drive a rotor attached to the shaft that functions as a motor producing rotational movement of the shaft without the use of permanent magnets. The non-magnetic electrically conductive rotor, as described in more detail below, will have an induced current such that the induced current always tends to oppose the cause which produced it; hence the associated magnetic field will be in opposition with the stator generated field producing motion of the rotor by repulsive force of like poles.

### DESCRIPTION OF PREFERRED EMBODIMENT

FIG. 1 illustrates an exemplary embodiment of a no-magnet slice motor according to the present invention in a three-dimensional isometric view. The rotational no-magnet linear motor 100a consists of a single stator element with core windings arranged in a cylindrical grouping, a non-magnetic electrically conductive cylindrical rotor that is not visible in the current view, 300 rotor end cover with integral impeller fins for enhanced cooling airflow through housing, 200 shaft, 500 electrical connections.

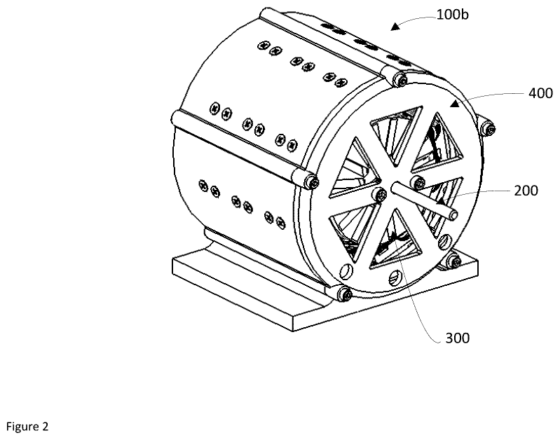

FIG. 2 illustrates an exemplary embodiment of a no-magnet three stator slice configured motor according to the present invention in a three-dimensional isometric view. The only difference between FIG. 1 and FIG. 2 is the length increased for three stator slices and a longer rotor.

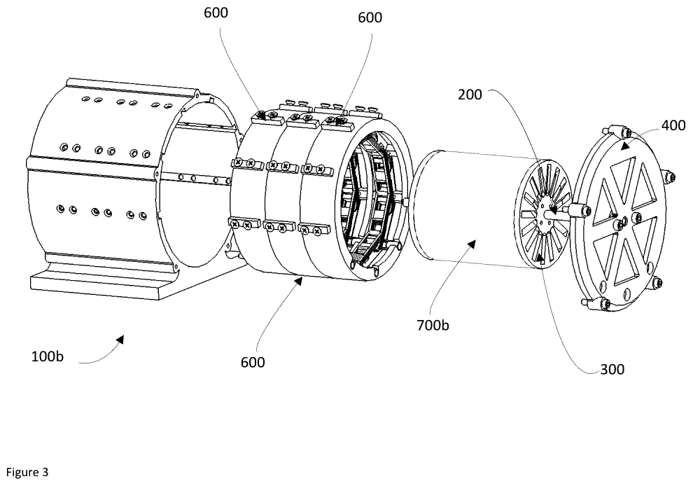

FIG. 3 illustrates an exploded view of the motor in a three-dimensional isometric view of a three stator slice configured motor. 300 is the integral rotor cover with integral impeller air flow fins to aid in heat removal on each side of the 700b cylindrical non-magnetic electrically conductive rotor. 600 is the stator slices with a linear motor configured in a cylindrical design. 400 is the motor front cover. The motor is configured in three stator slices; more or fewer slices can be added to configure the motor, as the identical stator slices are plug-able to each other.

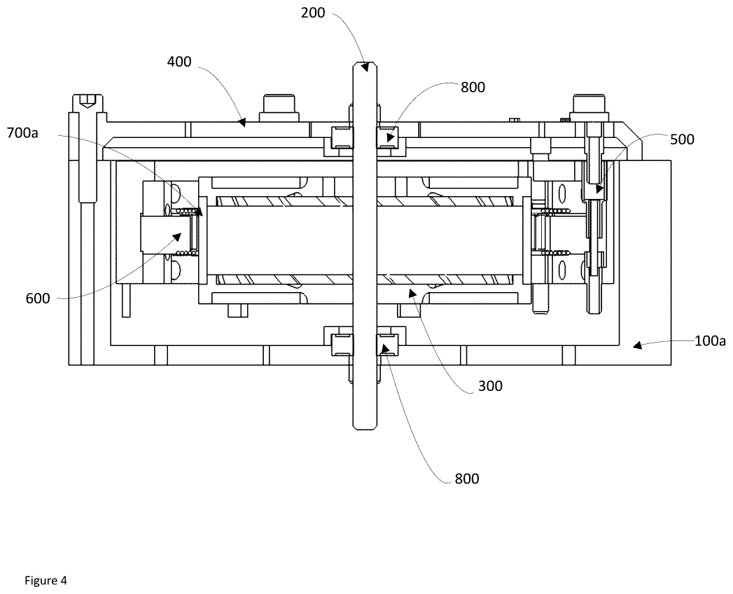

FIG. 4 illustrates a cut away view through the center of the present embodiment of the motor. Clearly shown is a single stator slice configured motor: 100a is the single slice assembly configured in length to house a single stator slice, 200 shaft, 300 rotor cover, 400 motor cover, 500 electrical connection, 600 stator slice, 700a rotor configured in length for a single stator slice.

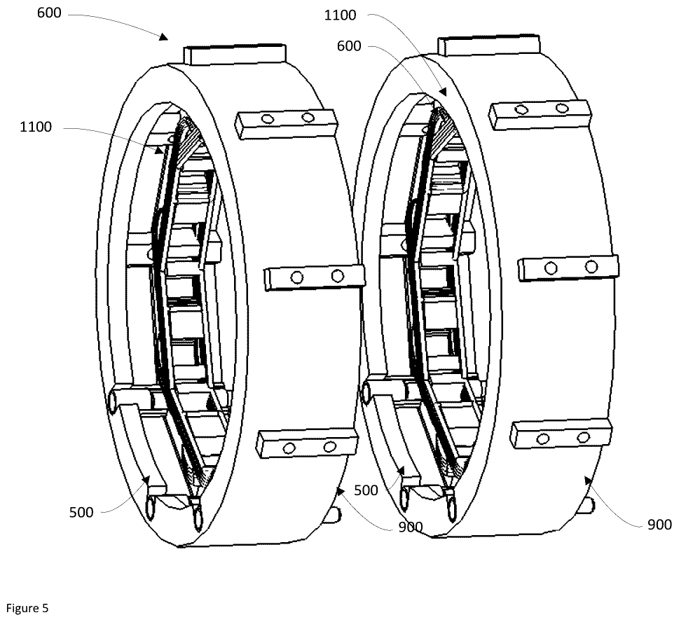

FIG. 5 illustrates 500 female electrical connector, 600 stator slice, and 900 male electrical connector. 1100 windings are interlaced on cores in a configuration of a linear motor. Clearly shown is the plug-ability of two slices together.

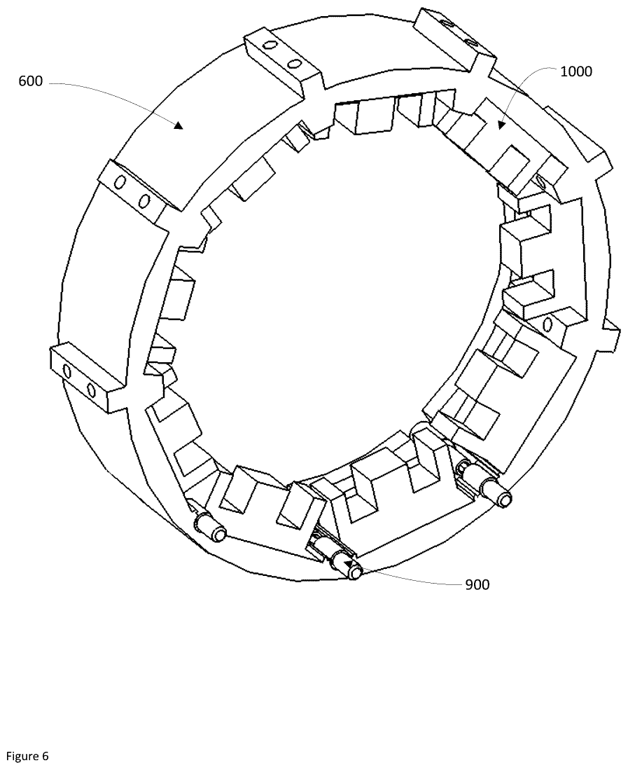

FIG. 6 illustrates how stator cores, 1000, can be arranged in a cylindrical configuration to 600 slice housing which accepts interlaced coil windings (not shown) for a continuous linear motor train to drive cylindrical rotor rotation. This drawing shows the definition of a single stator slice configuration, after the appropriate windings are added.

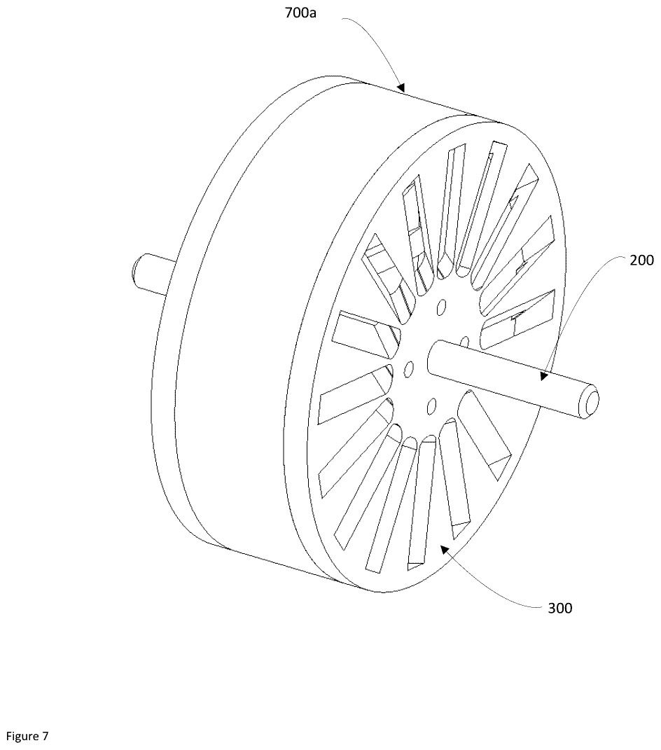

FIG. 7 shows a three-dimensional isometric view 700a single configured rotor, 200 shaft and 300 rotor cover with integral cooling air fins supporting rotor on shaft.

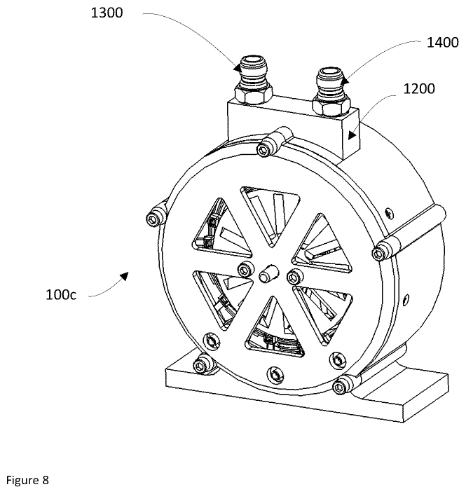

FIG. 8 illustrates an exemplary embodiment of a no-magnet slice motor according to the present invention in a three-dimensional isometric view. The rotational no-magnet linear motor 100c consists of a single stator element with core windings arranged in a cylindrical grouping, a non-magnetic electrically conductive cylindrical rotor that is not visible in the current view, 1200 Cooling manifold, 1300 coolant inlet and 1400 coolant exhaust.

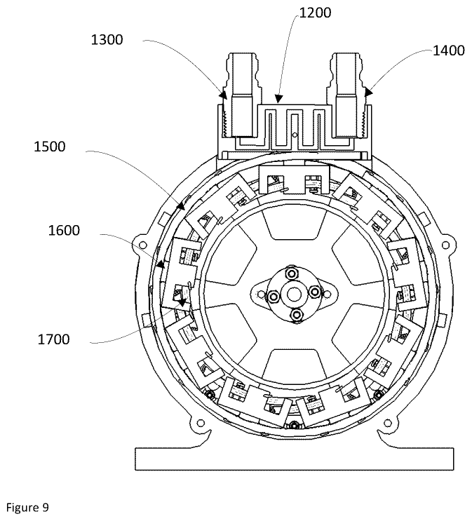

FIG. 9 illustrates a cut away view through the center of the present embodiment of the motor and integral cooling system. Clearly shown is a single stator slice configured motor: 100c is the single slice assembly configured in length to house a single stator slice with cooling manifold configured on top of housing, 2100 cooling manifold, 1300 coolant inlet, 1400 coolant outlet, 1500 heat pipe, 1600 high thermal conductive via, 1700 high thermal conductive epoxy placed between via, windings, heatpipe and cores.

1. No-magnet motor drive system for the acceleration of a rotational cylindrical rotor with shaft using induced currents in a non-magnetic electrically conductive rotor.

2. Speed control of the motor by varying the input current frequency.

3. Cylindrical configured stator linear motor coils arranged in a configuration around non-magnetic electrically conductive cylindrical rotor.

4. Design for a simple non-magnet motor that can produce rotational shaft movement using an easily configurable expandable motor design plug-able stator slice sub-assemblies.
